(19) United States
(12) Patent Application Publication
(10) Pub. No.: US 2024/0028671 A1
(43) Pub. Date: Jan. 25, 2024

(54) TECHNIQUES FOR ENFORCING SOFTWARE LICENSING OF SOFTWARE FILE EMBEDDED IN ELECTRONIC DEVICE

(71) Applicant: Analog Devices International Unlimited Company, Limerick (IE)

(72) Inventors: Rajesh Mahapatra, Bangalore (IN); Gopakumar Venugopal, Bangalore (IN); Kiran Srinivasa, Bangalore (IN)

(21) Appl. No.: 18/201,517

(22) Filed: May 24, 2023

Related U.S. Application Data
(60) Provisional application No. 63/391,937, filed on Jul. 25, 2022.

(51) Int. Cl. G06F 21/12; G06F 21/16

(52) U.S. Cl. CPC G06F 21/121; G06F 21/16

(57) ABSTRACT

This disclosure describes a software licensing process that can be divided into two phases: 1) during production of electronic devices and 2) a renewal phase during operations after the electronic devices are deployed. In the first phase, a default software license goes out along with the firmware when the electronic devices are manufactured. The default software license does not need a hardware unique ID (HUID) and can be part of the firmware file, which makes it easy for manufacturing personnel. The second phase is the renewal phase. Before or after expiration of the software license, a customer can collect and send the HUIDs of the electronic devices to the licensor, e.g., manufacturer, and the licensor can generate a single software license for multiple devices.

### CLAIM OF PRIORITY

This application claims priority to U.S. Provisional Application Serial No. 63/391,937, titled “TECHNIQUES FOR ENFORCING SOFTWARE LICENSING OF SOFTWARE FILE EMBEDDED IN ELECTRONIC DEVICE” to Raj esh Mahapatra et al., filed Jul. 25, 2022, which is incorporated by reference herein in its entirety.

### FIELD OF THE DISCLOSURE

This document pertains generally, but not by way of limitation, to software licensing of a software file embedded in an electronic device.

### BACKGROUND

Software licensing can ensure that only electronic devices that have a valid software license are fully operational. Most software licensing schemes of a software license file embedded in an electronic device use a hardware unique ID

(HUID) to enforce licensing, which can present challenges. For example, it can be difficult to obtain the HUID when the electronic device is in a warehouse because an HUID is generally embedded in the product. Obtaining an HUID of an electronic device, generating a license, and then programming the license into the electronic device adds cost and delay during production and shipping.

In addition, there are often many embedded devices and sometimes those devices are not connected to a server. A person applying the licenses to the devices can make mistakes when required to generate one license for each device.

### SUMMARY OF THE DISCLOSURE

This disclosure describes a software licensing process that can be divided into two phases: 1) during production of electronic devices and 2) a renewal phase during operations after the electronic devices are deployed. In the first phase, a default software license goes out along with the firmware when the electronic devices are manufactured. The default software license does not need a hardware unique ID (HUID) and can be part of the firmware file, which makes it easy for manufacturing personnel. For example, a single file can be programmed into a flash memory device of the electronic device. The default software license allows devices to run for a pre-determined duration that is set when the license file is generated.

The second phase is the renewal phase. After the pre-determined duration is over, a license would be invalid and would need to be renewed. Before or after expiration of the software license, a customer can collect and send the HUIDs of the electronic devices to the licensor, e.g., manufacturer, and the licensor can generate a single software license for multiple devices. All the HUIDs would be part of the “renewal license” file along with additional information such as a license ID, a duration of license, which features are enabled, a software type, a software release ID, and a number of units, for example.

In some claims, this disclosure is directed to a method of enforcing software licensing of a software file embedded in at least one electronic device, the method comprising: during production of the at least one electronic device: generating a software license, wherein the software license includes at least a license duration; generating, using the software license, the software file; storing the software file in a memory device of the at least one electronic device; and after deployment of the at least one electronic device: determining, without using a corresponding hardware unique ID of the at least one electronic device, whether the software license is valid.

In some claims, this disclosure is directed to a method of renewing a software license of a software file embedded in a plurality of electronic devices, the method comprising: generating the software license, wherein the software license includes at least a license duration and hardware unique IDs corresponding to the plurality of electronic devices; transmitting the software license to a customer; storing the same software license in corresponding memory devices of the plurality of electronic devices; and determining whether the software license is valid.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a simplified block diagram of an example of an electronic device that can implement various licensing techniques of this disclosure.

FIG. 2 is a flow diagram depicting an example of a method of generating a software license file and a software file.

FIG. 3 is a flow diagram depicting an example of a method of generating a software license file and a software file.

FIG. 4 is a flow diagram depicting an example of a method of enforcing software licensing of a software file embedded in at least one electronic device during a manufacturing phase.

FIG. 5 is a flow diagram depicting an example of a method of enforcing software licensing of software files embedded in a plurality of electronic devices during a renewal phase.

### DETAILED DESCRIPTION

The present inventors have recognized the challenges of the software licensing schemes described above and have developed a software licensing process for electronic devices that does not have to use a real time clock (RTC) or need network connectivity. This software licensing process can ensure there is no loss of software revenue and that only electronic devices that have a valid license are fully operational.

This disclosure describes a software licensing process that can be divided into two phases: 1) during production of electronic devices and 2) a renewal phase during operations after the electronic devices are deployed. In the first phase, a default software license goes out along with the firmware when the electronic devices are manufactured. The default software license does not need a hardware unique ID (HUID) and can be part of the firmware file, which makes it easy for manufacturing personnel. For example, a single file can be programmed into a flash memory device of the electronic device. The default software license allows devices to run for a pre-determined duration that is set when the license file is generated.

The second phase is the renewal phase. After the pre-determined duration is over, a license would be invalid and would need to be renewed. Before or after expiration of the software license, a customer can collect and send the HUIDs of the electronic devices to the licensor, e.g., manufacturer, and the licensor can generate a single software license for multiple devices. All the HUIDs would be part of the “renewal license” file along with additional information such as a license ID, a duration of license, which features are enabled, a software type, a software release ID, and a number of units, for example.

In some examples, the license files are encrypted using a key and then the encrypted files are signed to ensure that the license file is tamper proof.

In some examples, the license file can be stored in a flash location different from where the licensed software program is stored. These locations can be password protected and the password can be part of the software program. The software program itself can be signed and encrypted. In some examples, the keys for encryption and signature verification are stored in a one-time programmable device (OTP), for example, and external access to the keys for encryption and signature verification can be disabled for security.

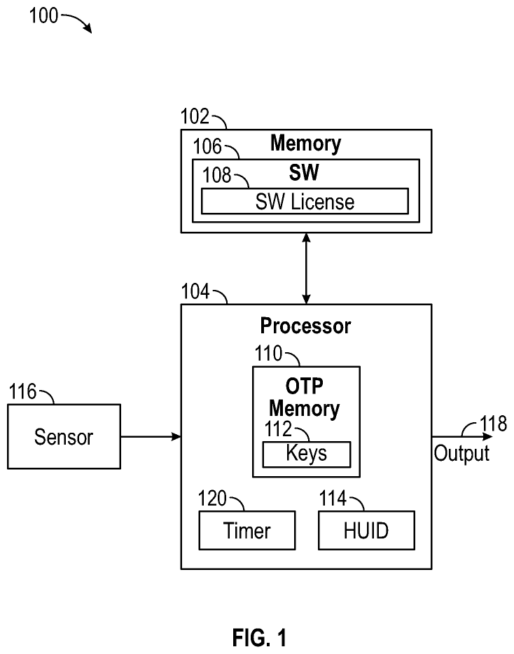

FIG. 1 is a simplified block diagram of an example of an electronic device 100 that can implement various licensing techniques of this disclosure. The electronic device 100 can include a memory device 102 and a processor 104. The memory device 102 can be a non-volatile memory, such as a flash memory device. In some examples, the memory device 102 can be internal to the processor 104. The memory device 102 can store a software file 106 with a software license 108 as part of the software file 106. In other words, the software file 106 and the software license 108 are one file.

The processor 104 can be coupled to and in communication with the memory device 102. The processor can be a digital signal processor (DSP), a field- programmable gate array, or a microcontroller, for example. The processor 104 can include a one-time programmable (OTP) memory 110 that stores encryption and signature verification keys 112, such as public encryption keys. In addition, the processor 104 can store a hardware unique ID (HUID) 114, e.g., DNA. In some examples, the HUID 114 can be stored in the OTP memory 110.

The electronic device 100 can be coupled to receive input, such as from a sensor 116, such as a video device or an instrumentation device, e.g., such as for impedance measurement. The processor 104 can generate an output signal 118, such as through an external interface. The electronic device 100 can include a timer 120, such as a system clock.

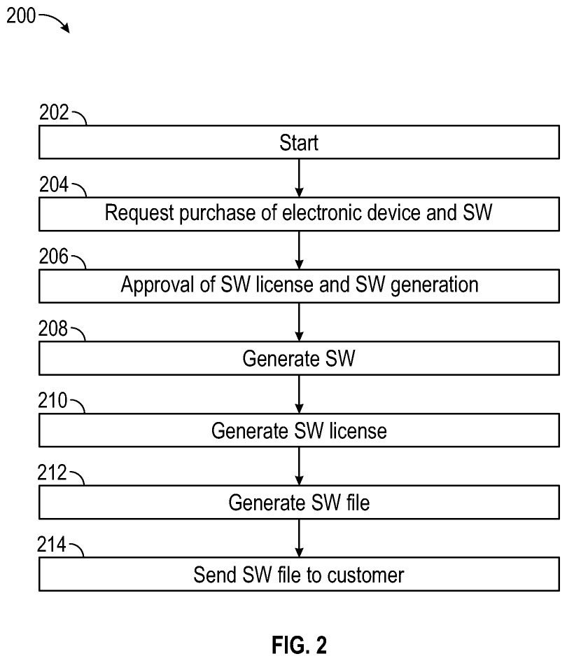

FIG. 2 is a flow diagram depicting an example of a method 200 of generating a software license file and a software file.

At block 202, the method 200 starts.

At block 204, a customer requests a purchase of at least one electronic device including software that is the subject of a software license. For example, a customer can send an email requesting the purchase of one or more electronic devices, such as the electronic device 100 of FIG. 1, to a manufacturer of the electronic devices.

At block 206, the method 200 includes approval of the software license and software file generation, such as the software file 106 and the software license 108 of FIG. 1. For example, a marketing manager of the manufacturer can approve the software license and software file generation and write an approved software license duration in the number of days in the software license.

At block 208, the method 200 includes generating the software file. For example, a system administrator can execute a software generation script with a software license duration and license type as inputs. For example, the script can read the license type, e.g., perpetual or recurring, license duration in days, the software type, software release ID, and destination email address. As a non-limiting example, if the license type is a perpetual license, then the license duration is 3650 days, otherwise the license duration is in days.

At block 210, the method 200 includes generating the software license, such as a default license. For example, the software license can be generated as a binary file and include a license ID, a license type, and a license duration, such as in days.

The software license can be encrypted and signed, such as using the encryption and signature verification keys 112 of FIG. 1. The generated software license can be stored in a kit server, for example, as a repository.

At block 212, the method 200 includes generating a software file, such as a flash file including the software file 106 and the software license 108 of FIG. 1.

At block 214, the method includes sending the software file to the customer, which can then be programmed into the memory 102.

Using the techniques of this disclosure, an HUID is not needed to generate the software license during the manufacturing phase. Rather, a default license can be applied during production, which can reduce the opportunity for error during production. There is no need to keep track of HUIDs and there is no chance of failure in the production line because of licensing issues. As described in more detail below, after deployment of the electronic device(s), the techniques of this disclosure can determine, without using a corresponding hardware unique ID of the electronic device(s), whether the software license is valid.

During initial bootup of the electronic device 100, the peripherals and the licensing scheme is initialized in the start function. As soon as the software license 108 is used, a specific or unique data pattern is written into the OTP memory 110 to ensure that the default license cannot be used again on the same device. During initial bootup, the processor 104 determines whether the unique data pattern is present in OTP memory 110. If the unique data pattern is present, then the default license has already been applied. Then, licensing scheme proceeds to determine whether there is a valid license file present, e.g., the software license 108, in a “factory license” section of the memory device 102.

If the electronic device 100 is booting up for the first time, no software license is applied and if a valid license is present in the “factory license” section of the memory device 102, then the default license is applied.

The software file 106 first verifies the signature of the software license 108 and then decrypts the software license using the keys that are programed in the OTP memory 110. The software file 106 then verifies the license data, writes the license data to the memory device 102, and updates the OTP memory 110 to indicate that the default license is applied and cannot be reused.

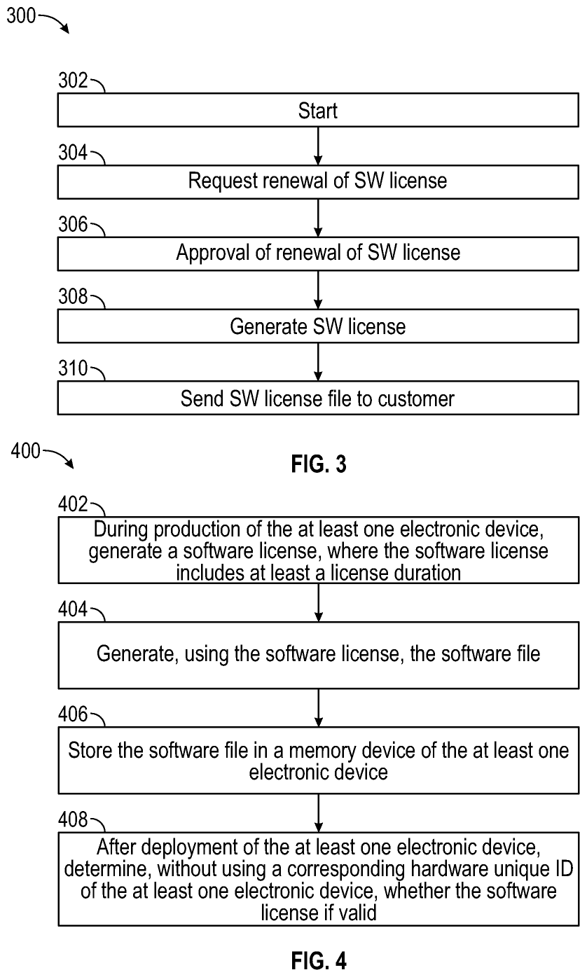

FIG. 3 is a flow diagram depicting an example of a method 300 of generating a software license file and a software file.

At block 302, the method 300 starts.

At block 304, a customer, e.g., a system administrator, requests renewal of a software license for at least one electronic device that includes software that is the subject of the software license. For example, a customer can send an email requesting the renewal of a software license of one or more electronic devices, such as the electronic device 100 of FIG. 1.

At block 306, the method 300 includes approval of a renewal of the software license, such as the software license 108 of FIG. 1. For example, a marketing manager can approve renewal of the software license and write an approved software license duration in the number of days in a field.

At block 308, the method 300 includes generating the software license. For example, a system administrator can execute a software generation script with a software license duration and license type as inputs. For example, the script can read the license type, e.g., perpetual or recurring, license duration in days, the software type, software release ID, a list of HUIDs that correspond with the electronic devices that include software that is the subject of the license renewal, and destination email address. As a non-limiting example, if the license type is a perpetual license, then the license duration is 3650 days, otherwise the license duration is in days.

In an example, the software license can be generated as a binary file and include the license ID, license type, license duration, such as in days, and a list of the HUIDs. In an example, the software license can be encrypted and signed, such as using the encryption and signature verification keys 112 of FIG. 1. The generated software license can be stored in a kit server, for example, as a repository.

At block 310, the method includes sending the software license to the customer, which can then be programmed into the memory 102.

During the renewal phase, the software license file sent to the customer is not the full firmware, just the software license. The software license file is a single file for all the electronic devices originally identified by the customer in the request at block 304. For example, if the customer requested software license renewal for 100 electronic devices, the single software license file sent to the customer would include 100 HUIDs that correspond to the 100 electronic devices. When applied, the software license file is combined with the software file 106.

During the renewal phase, the software on the electronic device 100 determines whether the HUID stored in the processor 104 is part of the list of HUIDs in the software license that was received. For example, the software can convert the HUID, such as 256 bits or 32 bytes long, into an array of eight 32-bit unsigned integers and compare the 2 HUIDs. This process can reduce the comparison to eight smaller comparisons.

The software can determine whether the licensing has been tampered with, such as by determining whether an Array of License IDs CRC is intact. If the CRC fails, then the license has been tampered with.

When the new software license is applied, the software determines whether a renewal license is being applied for the first time. The software can generate an empty license ID list in the Array of License IDs section of the memory device 102, initialize this section, add the default License ID to the list, and encrypt the data before writing the license data and the total duration of the license to the memory device 102. The license data can be encrypted using the encryption keys 112.

If the software determines that a renewal license is not being applied for the first time, the software reads the list of license IDs from the Array of License IDs and checks through the list to find out if the license ID is reused. If the license ID is not being reused, then the total duration of the license store in the memory device 102 will be updated and stored.

FIG. 4 is a flow diagram depicting an example of a method 400 of enforcing software licensing of a software file embedded in at least one electronic device during a manufacturing phase. Additional optional details of FIG. 4 are shown and described above with respect to FIG. 2.

At block 402, the method 400 includes, during production of the at least one electronic device, generating a software license, where the software license includes at least a license duration.

At block 404, the method 400 includes, during production of the at least one electronic device, generating, using the software license, the software file.

At block 406, the method 400 includes, during production of the at least one electronic device, storing the software file in a memory device of the at least one electronic device.

At block 408, the method 400 includes, after deployment of the at least one electronic device, determining, without using a corresponding hardware unique ID of the at least one electronic device, whether the software license is valid.

In some examples, the method 400 includes, during production of the at least one electronic device, before storing the software file in the memory device, encrypting the software file. Then, after deployment of the at least one electronic device, the method 400 includes decrypting the software file and determining the license duration of the software license.

In other examples, the method 400 includes, after deployment of the at least one electronic device, disabling output data of the at least one electronic device when the software license is determined to be invalid.

In some examples, the method 400 includes, after deployment of the at least one electronic device, outputting data representing licensing information, such as a license status and/or a license duration.

In other examples, the method 400 includes, after deployment of the at least one electronic device, storing, after a first use of the at least one electronic device, data representing a public key in a one-time programmable device of the at least one electronic device, where the data representing a public key prevents the software license from being reused on another electronic device or after the license duration. Then, method 400 includes disabling access to the one-time programmable device to secure the data representing the public key.

When the electronic device 100 is deployed and running, the output signal 118 provides output data or metadata over any supported interface, such as UART, if the electronic device 100 has a valid software license 108. If the software license 108 is not present or has expired, then output data will not be sent over any supported interface until a valid software license 108 is applied. In some examples, the electronic device 100 can send license status information over any supported interface. The output signal 118 can include the remaining days for license expiry, which can be used by the system operation manager to know when a software license 108 is to be renewed.

In some examples, the method 400 includes, after deployment of the at least one electronic device, counting time with a timer to determine if the license duration has been exceeded. For example, the timer 120 of FIG. 1 can count time to determine if the duration of the software license 108 has been exceeded. It should be noted that the techniques of this disclosure do not require use of a real time clock (RTC) to enforce licensing, in contrast to other approaches. That is, expiry is based on actual usage, e.g., number of days used, based on any timer in system, and not on a calendar year.

In other examples, the method 400 includes, after deployment of the at least one electronic device, counting a number of video frames to determine if the license duration has been exceeded. For example, when the sensor 116 is a video device and when electronic device 100 boots up, the electronic device 100 counts the number of video frames processed and stores the number of video frames operated periodically into two memory sections of the memory device 102. Once this duration exceeds the license duration, the software file 106 disables the output signal 118, which can include metadata such as occupancy, the number of people detected, etc.

When the electronic device 100 boots up for the very first time, it does not look for an HUID to validate the license. Instead, the electronic device 100 validates the software license 108 based on electronic signature keys 112 and then decrypts the software license 108 using the public encryption keys 112 to read the license type and license duration. This is the first step and this makes it very easy to deploy the electronic device 100.

For license renewal, a customer can send information such as the license type, the license duration, the software type and the software release number to the supplier to request renewal. In addition, the customer sends a list of HUIDs corresponding to the electronic devices 100 which need license renewal.

The supplier can generate the software license 108 with a license ID, a license type, a license duration and a list of the HUIDs that need activation. Using the techniques of this disclosure, a single software license 108 is generated that can be applied to multiple electronic devices 100, in contrast to other renewal techniques where a software license 108 corresponds to a particular electronic device 100. All the electronic devices 100 in a single building or floor may be all stored in a single software license 108. Using a single software license 108 for license renewal for multiple devices simplifies the renewal process.

The license file can then be encrypted and signed, such as using the same keys that are used to sign and encrypt firmware. Alternatively, a separate set of keys can be used just for this purpose.

Once the software license 108 is applied, the electronic device 100 checks the signature on the software license 108 using the keys 112 to validate the software license 108. Using the keys 112, the electronic device 100 decrypts the software license 108 to determines its content. The electronic device 100 looks at the license ID and if the license ID has not been previously used (e.g., unique), then the electronic device 100 looks at the HUIDs listed in the software license 108. If any of the HUIDs matches the HUID 114 of the electronic device 100, then the electronic device 100 validates the software license 108 and adds the time given in the software license 108 to its own time for the operation. For example, if the software license 108 includes a duration of 3 years, the electronic device 100 will add 3 years to the existing license validity time.

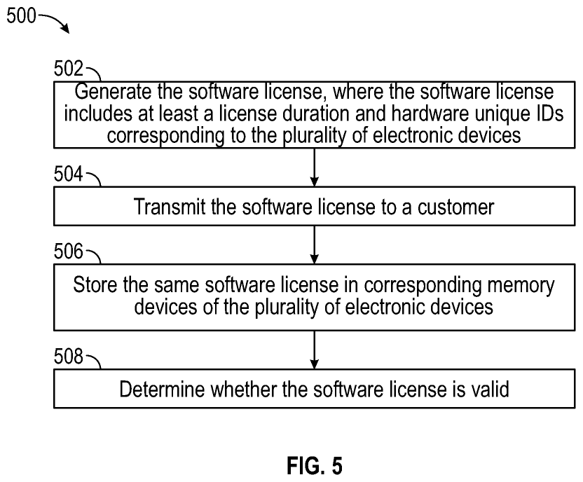

FIG. 5 is a flow diagram depicting an example of a method 500 of enforcing software licensing of software files embedded in a plurality of electronic devices during a renewal phase. Additional optional details of FIG. 5 are shown and described above with respect to FIG. 3.

At block 502, the method 500 includes, during a renewal phase of the software licenses embedded in a plurality of electronic devices, generating the software license, where the software license includes at least a license duration and hardware unique IDs corresponding to the plurality of electronic devices.

At block 504, the method 500 includes, during the renewal phase, transmitting the software license to a customer.

At block 506, the method 500 includes, during the renewal phase, storing the same software license in corresponding memory devices of the plurality of electronic devices.

At block 508, the method 500 includes, during the renewal phase, determining whether the software license is valid.

In some examples, the method 500 can include, before transmitting the software license to a customer, encrypting the software license and applying a digital signature to the encrypted software license.

In some examples, determining whether the software license is valid includes: verifying the digital signature; decrypting the software license; verifying a license ID; and verifying a device hardware unique ID with the at least one hardware unique ID of the software license.

In some examples, verifying the device hardware unique ID with the at least one hardware unique ID of the software license includes comparing the device hardware unique ID stored in the electronic device with a hardware unique ID of the software license.

In some examples, the method 500 includes, when the device hardware unique ID stored in the electronic device matches a hardware unique ID of the software license, incrementing a license validity time by the license duration of the software file.

Upon receiving the software license 108, the customer, such as a systems administrator, can update the electronic device 100 via a network connection or a host such using SPI (Serial Peripheral Interface), UART (Universal Asynchronous Receiver Transmitter), USB, I2C , and the like. If using a network connection, the software license 108 can be uploaded to a server and customer connectivity, e.g., WiFi, Ethernet, etc., can be used to apply the software license 108 to the electronic devices 100.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non- volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A method of enforcing software licensing of a software file embedded in at least one electronic device, the method comprising:
during production of the at least one electronic device:
generating a software license, wherein the software license includes at least a license duration;
generating, using the software license, the software file;
storing the software file in a memory device of the at least one electronic device;
after deployment of the at least one electronic device:
determining, without using a corresponding hardware unique ID of the at least one electronic device, whether the software license is valid.

2. The method of claim 1, comprising:
during production of the at least one electronic device:
before storing the software file in the memory device, encrypting the software file;
after deployment of the at least one electronic device:
decrypting the software file; and
determining the license duration of the software license.

3. The method of claim 1, comprising:
after deployment of the at least one electronic device:
disabling output data of the at least one electronic device when the
software license is determined to be invalid.

4. The method of claim 3, comprising:
after deployment of the at least one electronic device:
outputting data representing license information.

5. The method of claim 1, comprising:
after deployment of the at least one electronic device:
storing, after a first use of the at least one electronic device, data representing a unique data pattern in a one-time programmable device of the at least one electronic device, wherein the data representing the unique data pattern prevents the software license from being reused on the same electronic device again or after the license duration.

6. The method of claim 1, comprising:
after deployment of the at least one electronic device:
counting time with a timer to determine if the license duration has been exceeded.

7. The method of claim 1, comprising:
after deployment of the at least one electronic device:
counting a number of video frames to determine if the license duration has been exceeded.

8. A method of renewing a software license of a software file embedded in a plurality of electronic devices, the method comprising:
generating the software license, wherein the software license includes at least a license duration and hardware unique IDs corresponding to the plurality of electronic devices;
transmitting the software license to a customer;
storing the same software license in corresponding memory devices of the plurality of electronic devices; and
determining whether the software license is valid.

9. The method of claim 8, comprising:
before transmitting the software license to a customer:
encrypting the software license; and
applying a digital signature to the encrypted software license.

10. The method of claim 9, wherein determining whether the software license is valid includes:
verifying the digital signature;
decrypting the software license;
verifying a license ID; and
verifying a device hardware unique ID with the at least one hardware unique ID of the software license.

11. The method of claim 10, wherein verifying the device hardware unique ID with the at least one hardware unique ID of the software license includes:
comparing the device hardware unique ID stored in the electronic device with a hardware unique ID of the software license.

12. The method of claim 11, comprising:
when the device hardware unique ID stored in the electronic device matches a hardware unique ID of the software license:
incrementing a license validity time by the license duration of the software file.
